(19) United States
(12) Patent Application Publication
(10) Pub. No.: US 2017/0190375 A1
(43) Pub. Date: Jul. 6, 2017

(54) Direction Control Method for Self-Balancing Electric Vehicle and Self-Balancing Electric Vehicle Using the Same

(71) Applicant: Generalplus Technology Inc., Hsinchu City (TW)

(72) Inventors: Li Sheng LO, Zhubei City (TW); Chih Hsiang YANG, Ho Mei Town (TW); Chia Sheng HSU, Hsin Chu City (TW); Yu Hsun WANG, Kao Hsiung City (TW); Chi Wei FAN, Hsinchu City (TW); Jing Jo BEI, Hsinchu City (TW)

(21) Appl. No.: 15/393,918

(22) Filed: Dec. 29, 2016

Related U.S. Application Data
(60) Provisional application No. 62/273,376, filed on Dec. 30, 2015.

(51) Int. Cl. B62K 11/00; B62K 23/08

(52) U.S. Cl. CPC B62K 11/007; B62K 23/08; B62K 2204/00; B62J 2300/0013

(57) ABSTRACT

A direction control method for the self-balancing electric vehicle and electric vehicle using the same are disclosed in the present invention. The direction control method for the self-balancing electric vehicle includes the following steps: disposing a plurality of direction control units under the foot treadles of the self-balancing electric vehicle, wherein each direction control unit comprises a first conductive plate, a second conductive plate and a flexible material, wherein the aforementioned flexible material is disposed between the first conductive plate and the second conductive plate; respectively measuring the capacitance values between the first conductive plates and the second conductive plates of the plurality of direction control units; and determining the tilt direction of the center of gravity of a riding object based on the capacitance values of the direction control units and the positions of the direction control units, such that the moving direction of the self-balancing electric vehicle can be determined.

This application claims priority to U.S. Provisional Patent Application Ser. No. 62/273,376 filed on Dec. 30, 2016 which is incorporated herein by reference in its entirety.

### BACKGROUND OF THE INVENTION

Field of the Invention

The present invention discloses a technology for the self-balancing electric vehicle. More specifically, the present invention discloses a direction control method for the self-balancing electric vehicle and the electric vehicle using the same.

Related Art

With the progress of the technology, the electronic technology has been progressed from the earliest vacuum tube and transistor to the integrated circuit chip, which has the quite wide applications. Thus, the electronic products have gradually become the indispensable essentials in the life of the modern human beings. In 2001, Dean Kamen and DEKA Company promote Segway Scooter which is a scooter with coaxial two wheels. As shown in FIG. 1, FIG. 1 illustrates a scooter with coaxial two wheels in the conventional art. Referring to FIG. 1, the speed of the scooter can reach 20 km/hr. It uses three gyroscopes to balance its car body. In addition, there are two spare gyroscopes in the scooter. The revolute pair connection between the handrail and chassis can support the driver's balance with the inclined body during cornering action.

The conventional self-balancing two-wheel electric vehicle uses the handlebar (steering head) to drive both the left and right wheels to create a speed difference. For example, when the handlebar turns left, the speed of the right wheel is faster than that of the left wheel, resulting in the effect of turning left. However, the problem is that the control of turning left or right still is limited to the operation by both hands which interferes the ultimate experience created by the balancing act due to the operation of turning left or right direction. After all, such mode of operation is in no difference from that of a regular electric vehicle. On the other hand, the Ninebot of Xiaomi uses the leg-manipulation to control the direction and attempts to solve the aforementioned problem. Nevertheless, in reality, the effect of the leg-manipulation results in the decrease in sensitivity and the increase of tension in rider's lower part of body. The handlebar-free self-balancing electric vehicle currently available adopts an operation that two wheels are separately and independently controlled, and thus its structure is much more complex.

### SUMMARY OF THE INVENTION

It is therefore an objective of the present invention to provide a direction control method for the self-balancing electric vehicle and self-balancing electric vehicle using the same. By utilizing the deformation of the capacitor sensing device, the center of gravity of each foot can be determined, so that the moving direction of the self-balancing electric vehicle can be controlled.

In view of this, the present invention provides a direction control method for the self-balancing electric vehicle. The direction control method for the self-balancing electric vehicle comprises: providing a plurality of direction control units under a foot treadle of the self-balancing electric vehicle, wherein each of the direction control units comprises a first conductive plate, a second conductive plate and a flexible material, disposed between the first conductive plate and the second conductive plate; respectively detecting a capacitance value between the first conductive plate and the second conductive plate of each of direction control units; and determining a tilt direction of a center of gravity of a riding object based on the capacitance value of every direction control unit and a position of every direction control unit, so that a moving direction of the self-balancing electric vehicle is determined.

The present invention further provides a self-balancing electric vehicle. The self-balancing electric vehicle comprises: a moving element, a first foot treadle, a second foot treadle, and a control circuit. The moving element is for moving the self-balancing electric vehicle. The first foot treadle comprises a plurality of first direction control units. The second foot treadle comprises a plurality of second direction control units. The control circuit is coupled to the moving element, the first direction control units and the second direction control units. Each of the first direction control units and the second direction control units comprises a first conductive plate, a second conductive plate and a flexible material, wherein the flexible material disposed between the first conductive plate and the second conductive plate. The control circuit respectively detects a capacitance value between the first conductive plate and the second conductive plate of each of the first direction control units and the control circuit respectively detects a capacitance value between the first conductive plate and the second conductive plate of each of the second direction control units. The control circuit determines a tilt direction of a center of gravity of a riding object based on the capacitance value of every first direction control unit, the capacitance value of every second direction control unit, a position of every first direction control unit and a position of every second direction control unit, so that a moving direction of the self-balancing electric vehicle is determined.

In accordance with the exemplary embodiments of the present invention, the control circuit detects the center of gravity by the direction control units respectively disposed on the first foot treadle and the second foot treadle. The control circuit controls the self-balancing electric vehicle to turn right when a center of gravity of the first foot treadle leans to a right side and a center of gravity of the second foot treadle leans to the right side. And, the control circuit controls the self-balancing electric vehicle to turn left when the center of gravity of the first foot treadle leans to a left side and the center of gravity of the second foot treadle leans to the left side. Further, the first foot treadle can be set as a left foot treadle and the second foot treadle can be set as a right foot treadle. The control circuit controls the self-balancing electric vehicle to turn right in place when the center of gravity of the left foot treadle leans to a front side and the center of gravity of the right foot treadle leans to a back side. The control circuit controls the self-balancing electric vehicle to turn left in place when the center of gravity of the left foot treadle leans to the back side and the center of gravity of the right foot treadle leans to the front side.

In accordance with the exemplary embodiments of the present invention, the first foot treadle comprises a first direction control unit, a second direction unit, a third direction control unit and a fourth direction control unit, wherein the first direction control unit, the second direction control unit, the third direction control unit and the fourth direction control unit are respectively with a first coordinate (X1 ,Y1), a second coordinate (X2,Y2), a third coordinate (X3,Y3) and a fourth coordinate (X4,Y4). The second foot treadle comprises a fifth direction control unit, a sixth direction control unit, a seven direction control unit and an eighth direction control unit, wherein the fifth direction control unit, the sixth direction control unit, the seventh direction control unit and the eighth direction control unit r are respectively with a fifth coordinate (X5,Y5), a sixth coordinate (X6,Y6), a seventh coordinate (X7,Y7) and an eighth coordinate (X8,Y8). The control circuit respectively detects the variations of the capacitance values ΔC1, ΔC2, ΔC3 and ΔC4 of the first direction control unit, the second direction control unit, the third direction control unit and the fourth direction control unit and calculates the coordinate of the center of gravity based on the aforementioned variations of the capacitance values, as follows:

XW1=(ΔC1×X1+ΔC2×X2×ΔC3×X3+ΔC4×X4)/(AC1×ΔC2+ΔC3+ΔC4)

YW1=(C1×Y1×ΔC2×Y2+ΔC3×Y3+ΔC4×Y4)/(AC1×ΔC2+ΔC3+ΔC4)

Where (XW1,YW1) is the coordinate of the center of gravity on the first foot treadle. The control circuit respectively detects the variations of the capacitance values ΔC5, ΔC6, ΔC7 and ΔC8 of the fifth direction control unit, the sixth direction control unit, the seventh direction control unit and the eighth direction control unit and calculates the coordinate of the center of gravity based on the aforementioned variations of the capacitance values, as follows:

XW2=(ΔC5×X5+ΔC6×X6×ΔC7×X7×ΔC8×X8)/(C5+C6+C7+C8)

YW2=(ΔC5×Y5+ΔC6×Y6+ΔC7×Y7×ΔC8×Y8)/(ΔC5+ΔC6+ΔC7+ΔC8)

Where (XW2,YW2) is the coordinate of the center of gravity on the second foot treadle.

The spirit of present invention is to provide a plurality of capacitor sensing elements disposed under the foot treadles as the direction control units, to determine the center of gravity of the rider's each foot through the measurement of the capacitance between two metal plates of the capacitor sensing element and the coordinates of the direction control units, so as to determine the control of going forward or turning of the self-balancing electric vehicle. Therefore, the present invention uses a relatively simple structure to control the moving direction of the self-balancing electric vehicle.

Further scope of the applicability of the present invention will become apparent from the detailed description given hereinafter. However, it should be understood that the detailed description and specific examples, while indicating preferred embodiments of the present invention, are given by way of illustration only, since various changes and modifications within the spirit and scope of the present invention will become apparent to those skilled in the art from this detailed description.

### BRIEF DESCRIPTION OF THE DRAWINGS

FIG. 1 illustrates a schematic diagram of a two-wheeled, self-balancing scooter according to a prior art.

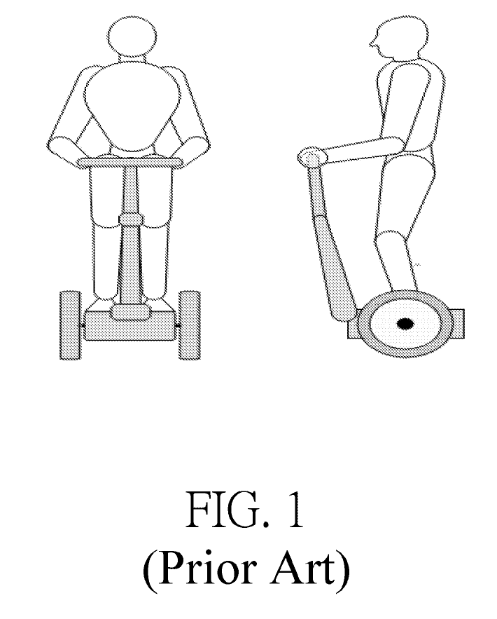

FIG. 2 illustrates a system block diagram of a self-balancing electric vehicle according to a preferred embodiment of the present invention.

FIG. 3 illustrates a structural schematic diagram of direction control units D21, D22, D23, D24, D25, D26, D27 and D28 of a self-balancing electric vehicle according to a preferred embodiment of the present invention

FIG. 4 illustrates a flowchart of the direction control method for the self-balancing electric vehicle according to a preferred embodiment of the present invention.

FIG. 5 illustrates a flowchart depicting sub-Steps of Step S404 in the direction control method for the self-balancing electric vehicle according to a preferred embodiment of the present invention.

### DETAILED DESCRIPTION OF THE INVENTION

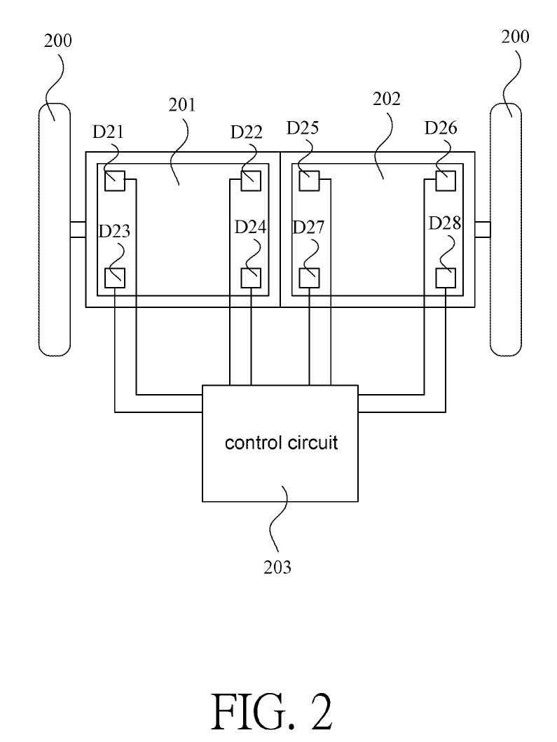

FIG. 2 illustrates a system block diagram of a self-balancing electric vehicle according to a preferred embodiment of the present invention. Please referring to FIG. 2, the self-balancing electric vehicle includes a moving element 200, a first foot treadle 201, a second foot treadle 202 and a control circuit 203. The moving element 200 is used for moving the self-balancing electric vehicle. The first foot treadle 201 includes four first direction control units D21, D22, D23 and D24. The second foot treadle 202 includes four second direction control units D25, D26, D27 and D28. The control circuit 203 is coupled to the moving element 200, four first direction control units D21, D22, D23 and D24, and four second direction control units D25, D26, D27 and D28. For example, the moving element 200 may be a wheel, a ball transfer or a caster, however, the present invention is not limited thereto.

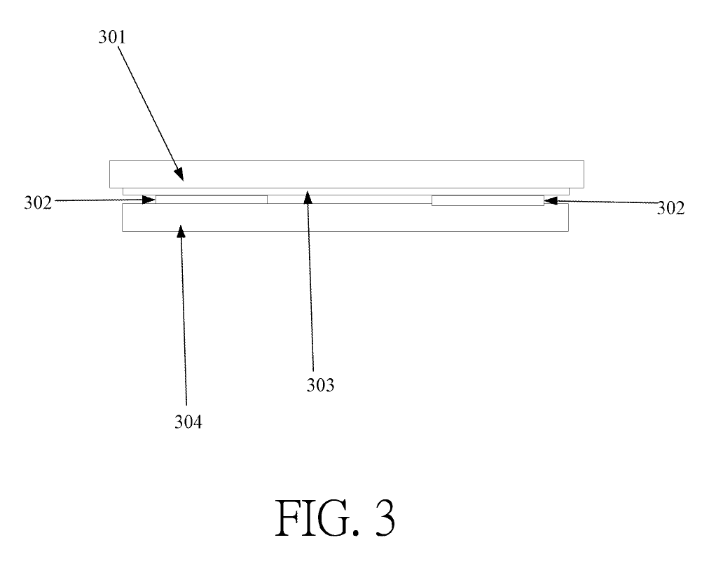

FIG. 3 illustrates a structural schematic diagram depicting the direction control units D21, D22, D23, D24, D25, D26, D27 and D28 of a self-balancing electric vehicle according to a preferred embodiment of the present invention. As referring to FIG. 3, the structure of a direction control unit includes a first conductive plate 301, a second conductive plate 302, a flexible material 303 and a printed circuit board (PCB) 304. The printed circuit board 304 is used for electrically coupling the second conductive plate 302 to the control circuit 203. The first conductive plate 301 is served as a ground plate. When an user steps on the foot treadles, the first conductive plate 301 receives a downward pressure. It causes a deformation of the flexible material 303 resulting in distance change between the second conductive plate 302 and the first conductive plate 301 and leading to a change in capacitance between the first conductive plate 301 and the second conductive plate 302. Furthermore, the distances between every second conductive plate 302 and the first conductive plate 301 are different according to different positions, which the downward pressure is applied to, and different levels of downward pressure.

In the beginning, the rider's sole step on four direction control units evenly, and an initial capacitance value is generated from each of four direction control units. Afterward, when the center of gravity of the foot is changed afterward, the distances between the first conductive plate 301 and the second conductive plates 302 of the four direction control units respectively are increased or decreased. For example, when the user's foot leans to the left side, the distances between the first conductive plates 301 and the second conductive plates 302 of two direction control units respectively located in the left side of the foot treadle are shortened, whereas the distances between the first conductive plates 301 and the second conductive plates 302 of two direction control units respectively located in the right side of the foot treadle are lengthened. Therefore, by detecting the capacitance values of the direction control units D21, D22, D23, D24, D25, D26, D27 and D28, the center of gravity of the rider's foot can be determined.

For instance, the first direction control units D21, D22, D23 and D24 of the first foot treadle 201 have a first coordinate (X1,Y1), a second coordinate (X2,Y2), a third coordinate (X3,Y3) and a fourth coordinate (X4,Y4), respectively. The second direction control units D25, D26, D27 and D28 of the second foot treadle 202 have a fifth coordinate (X5,Y5), a sixth coordinate (X6,Y6), a seventh coordinate (X7,Y7) and an eighth coordinate (X8,Y8), respectively. The method of measuring the center of gravity of rider's foot, which presses on the first foot treadle 201, used by the control circuit 203 includes:

Step 1: Retrieving the variations of the capacitance values ΔC1, ΔC2, ΔC3 and ΔC4 of the first direction control units D21, D22, D23 and D24 respectively from the control circuit 203.

Step 2: Calculating the coordinate of the center of gravity based on the variations of the capacitance values ΔC1, ΔC2, ΔC3 and ΔC4, as follows:

XW1=(ΔC1×X1+ΔC2×X2×ΔC3×X3+ΔC4×X4)/(AC1×ΔC2+ΔC3+ΔC4)

YW1=(C1×Y1×ΔC2×Y2+ΔC3×Y3+ΔC4×Y4)/(AC1×ΔC2+ΔC3+ΔC4)

where (XW1,YW1) is the coordinate of the center of gravity on the first foot treadle 201.

Similarly, the method of measuring the center of gravity of rider's foot, which presses on the second foot treadle 202, used by the control circuit 203 includes:

Step 1: Retrieving the variations of the capacitance values ΔC5, ΔC6, ΔC7 and ΔC8 of the second direction control units D25, D26, D27 and D28 respectively from the control circuit 203.

Step 2: Calculating the coordinate of the center of gravity based on the variations of the capacitance values ΔC5, ΔC6, ΔC7 and ΔC8, as follows:

XW2=(ΔC5×X5+ΔC6×X6×ΔC7×X7×ΔC8×X8)/(C5+C6+C7+C8)

YW2=(ΔC5×Y5+ΔC6×Y6+ΔC7×Y7×ΔC8×Y8)/(ΔC5+ΔC6+ΔC7+ΔC8)

where (XW2,YW2) is the coordinate of the center of gravity on the second foot treadle 202.

In addition, for the control of moving direction of the self-balancing electric vehicle, the control circuit 203 generates the control signal to the self-balancing electric vehicle based on the changes of the centers of gravity of both left and right feet respectively. When centers of gravity of two feet are both in the right side, the self-balancing electric vehicle is directed to turn right. When one foot leans forward and one foot leans back, the electric vehicle will turn left or right in place. The present invention can solve the problem of unable turning in place in the prior art, and allow the rider to experience better operability. The following Table 1 discloses a workable control scheme.

TABLE 1

| Center of gravity | Center of gravity | |
|---|---|---|
| of the left foot | of the right foot | Control Signal |
| left | left | Turn left |
| right | right | Turn right |
| front | back | Turn right in place |
| back | front | Turn left in place |

In general, the offset of the center of gravity in the aforementioned embodiment can be derived by using the center position of the foot treadle as the baseline. In another preferred embodiment, the capacitance variations is calculated to obtain the initial value of the center of gravity when the rider first stands on the self-balancing electric vehicle, and then to calculate the offset using this initial value of the center of gravity. However, the present invention is not limited thereto. Although, the aforementioned embodiment describes the left and right foot treadles having 4 direction control units as an example, people having ordinary skill in the art should know that the center of gravity of the surface can be calculated and derived by using 3 direction control units. Besides, if the consideration only focuses on the condition of turning the direction of the vehicle, using 2 direction control units is sufficient enough to control the action of left turn or right turn. Therefore, this embodiment is only an exemplificative preferred embodiment. The present invention is not limited to the quantity of the control units.

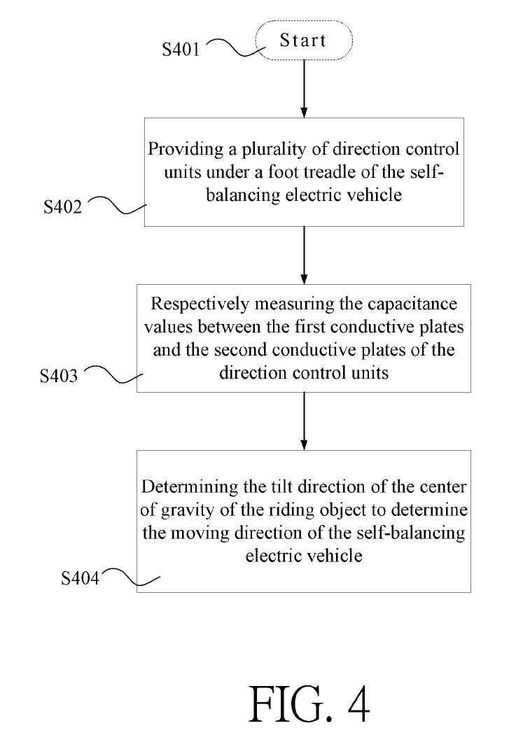

With reference to the aforementioned embodiments, the present invention can be summarized into a direction control method for self-balancing electric vehicles. FIG. 4 illustrates a flowchart diagram of the direction control method for the self-balancing electric vehicle of a preferred embodiment of the present invention. Please refer to FIG. 4. The direction control method for the self-balancing electric vehicle includes the steps as follows.

In step S401, the method starts.

In step S402, a plurality of direction control units is disposed under a foot treadle of the self-balancing electric vehicle. In this embodiment, each foot treadle 201 and each foot treadle 202 have four direction control units D21, D22, D23, D24, D25, D26, D27 and D28 installed thereunder. In addition, every direction control unit comprises a first conductive plate 301, a second conductive plate 302 and a flexible material 303. The flexible material 303 is disposed between the first conductive material 301 and the second conductive material 302.

In Step S403, the capacitance values between the first conductive plates and the second conductive plates of the direction control units are measured individually. The control circuit 203 acquires the capacitance values of C1, C2, C3, C4, C5, C6, C7 and C8.

In Step S404, the tilt direction of the center of gravity of the riding object is determined based on the capacitance value of every direction control unit and the position of every direction control unit, so that the moving direction of the self-balancing electric vehicle can be determined.

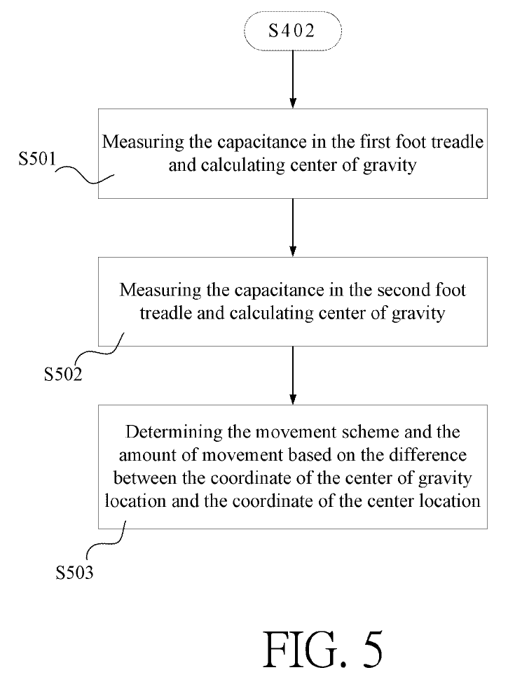

Furthermore, the step S404 includes the following sub-Steps, as shown in FIG. 5. FIG. 5 illustrates a flowchart diagram of sub-steps of Step S404 of the direction control method for the self-balancing electric vehicle of a preferred embodiment of the present invention. Please refer to FIG. 5 the step S404 includes the sub-steps as follows.

In Step S501, the capacitance in the first foot treadle is measured and the center of gravity is calculated based on the measured capacitance, wherein the location of the center of gravity is calculated based on the variations of every capacitance value ΔC1, ΔC2, ΔC3 and ΔC4 and every coordinate of the direction control units D21, D22, D23 and D24.

In Step S502, the capacitance in the second foot treadle is measured and the center of gravity is calculated based on the measured capacitance, wherein the location of the center of gravity is calculated based on the variations of every capacitance value ΔC5, ΔC6, ΔC7 and ΔC8 and every coordinate of the direction control units D25, D26, D27 and D27.

In Step S503, the movement scheme and the amount of movement is determined based on the difference between the coordinate of the center of gravity location and the coordinate of the center location, by the calculations in Step S501 and Step S502. Please refer to Table 1 for the movement scheme. The amount of movement (scale) is determined based on the difference between the coordinate of the center of gravity location and the coordinate of the center location, so that the speed of the moving element 200 is determined. In general, the larger the difference is, the faster the moving speed will be.

In summary, the spirit of the present invention is to provide a plurality of capacitor sensing elements disposed under the foot treadles as the direction control units, to determine the center of gravity of the rider's each foot through the measurement of the capacitance between two metal plates of the capacitor sensing element and the coordinates of the direction control units, so as to determine the control of going forward or turning of the self-balancing electric vehicle. Therefore, the present invention uses a relatively simple structure to control the moving direction of the self-balancing electric vehicle.

While the present invention has been described by way of examples and in terms of preferred embodiments, it is to be understood that the present invention is not limited thereto. To the contrary, it is intended to cover various modifications. Therefore, the scope of the appended claims should be accorded the broadest interpretation so as to encompass all such modifications.

What is claimed is:

1. A direction control method for a self-balancing electric vehicle comprises:
providing a plurality of direction control units under a foot treadle of the self-balancing electric vehicle, wherein each of the direction control units comprises:
a first conductive plate;
a second conductive plate; and
a flexible material, disposed between the first conductive plate and the second conductive plate;
respectively detecting a capacitance value between the first conductive plate and the second conductive plate of each of direction control units; and
determining a tilt direction of a center of gravity of a riding object based on the capacitance value of every direction control unit and a position of every direction control unit, so that a moving direction of the self-balancing electric vehicle is determined.

2. The direction control method for the self-balancing electric vehicle according to claim 1, wherein the foot treadle is a first foot treadle, the self-balancing electric vehicle comprises the first foot treadle and a second foot treadle;
wherein the direction control method for the self-balancing electric vehicle further comprises:
utilizing the direction control units respectively disposed on the first foot treadle and the second foot treadle to detect the center of gravity;
controlling the self-balancing electric vehicle to turn right when a center of gravity of the first foot treadle leans to a right side and a center of gravity of the second foot treadle leans to the right side; and
controlling the self-balancing electric vehicle to turn left when the center of gravity of the first foot treadle leans to a left side and the center of gravity of the second foot treadle leans to the left side.

3. The direction control method for the self-balancing electric vehicle according to claim 2, wherein the first foot treadle is a left foot treadle and the second foot treadle is a right foot treadle;
wherein the direction control method for the self-balancing electric vehicle further comprises:
controlling the self-balancing electric vehicle to turn right in place when the center of gravity of the left foot treadle leans to a front side and the center of gravity of the right foot treadle leans to a back side; and
controlling the self-balancing electric vehicle to turn left in place when the center of gravity of the left foot treadle leans to the back side and the center of gravity of the right foot treadle leans to the front side.

4. The direction control method for the self-balancing electric vehicle according to claim 1, wherein the foot treadle is a first foot treadle, the self-balancing electric vehicle comprises the first foot treadle and a second foot treadle;
wherein the first foot treadle comprises a first direction control unit, a second direction unit, a third direction control unit and a fourth direction control unit, wherein
the first direction control unit, the second direction control unit, the third direction control unit and the fourth direction control unit are respectively with a first coordinate (X1,Y1), a second coordinate (X2,Y2), a third coordinate (X3,Y3) and a fourth coordinate (X4,Y4);
wherein the second foot treadle comprises a fifth direction control unit, a sixth direction control unit, a seven direction control unit and an eighth direction control unit, wherein
the fifth direction control unit, the sixth direction control unit, the seventh direction control unit and the eighth direction control unit r are respectively with a fifth coordinate (X5,Y5), a sixth coordinate (X6,Y6), a seventh coordinate (X7,Y7) and an eighth coordinate (X8,Y8);
wherein the direction control method for the self-balancing electric vehicle further comprises:
detecting the center of gravity of the first foot treadle; and
detecting the center of gravity of the second foot treadle;
wherein detecting the center of gravity of the first foot treadle comprises:
respectively acquiring the variations of the capacitance values ΔC1, ΔC2, ΔC3 and ΔC4 of the first direction control unit, the second direction control unit, the third direction control unit and the fourth direction control unit; and
calculating the coordinate of the center of gravity based on the aforementioned variations of the capacitance values, as follows:
XW1=(ΔC1×X1+ΔC2×X2×ΔC3×X3+ΔC4×X4)/(AC1×ΔC2+ΔC3+ΔC4)
YW1=(C1×Y1×ΔC2×Y2+ΔC3×Y3+ΔC4×Y4)/(AC1×ΔC2+ΔC3+ΔC4)
where (XW1,YW1) is the coordinate of the center of gravity on the first foot treadle;
wherein detecting the center of gravity of the second foot treadle comprises:
respectively acquiring the variations of the capacitance values ΔC5, ΔC6, ΔC7 and ΔC8 of the fifth direction control unit, the sixth direction control unit, the seventh direction control unit and the eighth direction control unit; and
calculating the coordinate of the center of gravity based on the aforementioned variations of the capacitance values, as follows:
XW2=(ΔC5×X5+ΔC6×X6×ΔC7×X7×ΔC8×X8)/(C5+C6+C7+C8)
YW2=(ΔC5×Y5+ΔC6×Y6+ΔC7×Y7×ΔC8×Y8)/(ΔC5+ΔC6+ΔC7+ΔC8)
where (XW2,YW2) is the coordinate of the center of gravity on the second foot treadle.

5. A self-balancing electric vehicle comprises:
a moving element, for moving the self-balancing electric vehicle;
a first foot treadle, comprising a plurality of first direction control units;
a second foot treadle, comprising a plurality of second direction control units;
a control circuit, coupled to the moving element, the first direction control units and the second direction control units,
wherein each of the first direction control units and the second direction control units comprises:
a first conductive plate;
a second conductive plate; and
a flexible material, disposed between the first conductive plate and the second conductive plate;
wherein the control circuit respectively detects a capacitance value between the first conductive plate and the second conductive plate of each of the first direction control units and the control circuit respectively detects a capacitance value between the first conductive plate and the second conductive plate of each of the second direction control units; and
wherein the control circuit determines a tilt direction of a center of gravity of a riding object based on the capacitance value of every first direction control unit, the capacitance value of every second direction control unit, a position of every first direction control unit and a position of every second direction control unit, so that a moving direction of the self-balancing electric vehicle is determined.

6. The self-balancing electric vehicle according to claim 5, wherein the control circuit detects the center of gravity by the first direction control units disposed on the first foot treadle and the second direction control units disposed on the second foot treadle;
wherein the control circuit controls the self-balancing electric vehicle to turn right when a center of gravity of the first foot treadle leans to a right side and a center of gravity of the second foot treadle leans to the right side; and
wherein the control circuit controls the self-balancing electric vehicle to turn left when the center of gravity of the first foot treadle leans to a left side and the center of gravity of the second foot treadle leans to the left side.

7. The self-balancing electric vehicle according to claim 6, wherein the first foot treadle is a left foot treadle and the second foot treadle is a right foot treadle;
wherein the control circuit controls the self-balancing electric vehicle to turn right in place when the center of gravity of the left foot treadle leans to a front side and the center of gravity of the right foot treadle leans to a back side; and
wherein the control circuit controls the self-balancing electric vehicle to turn left in place when the center of gravity of the left foot treadle leans to the back side and the center of gravity of the right foot treadle leans to the front side.

8. The self-balancing electric vehicle according to claim 5, wherein the foot treadle is a first foot treadle, the self-balancing electric vehicle comprises the first foot treadle and a second foot treadle;
wherein the first foot treadle comprises a first direction control unit, a second direction unit, a third direction control unit and a fourth direction control unit, wherein the first direction control unit, the second direction control unit, the third direction control unit and the fourth direction control unit are respectively with a first coordinate (X1,Y1), a second coordinate (X2,Y2), a third coordinate (X3,Y3) and a fourth coordinate (X4,Y4);
wherein the second foot treadle comprises a fifth direction control unit, a sixth direction control unit, a seven direction control unit and an eighth direction control unit, wherein the fifth direction control unit, the sixth direction control unit, the seventh direction control unit and the eighth direction control unit r are respectively with a fifth coordinate (X5,Y5), a sixth coordinate (X6,Y6), a seventh coordinate (X7,Y7) and an eighth coordinate (X8,Y8);
wherein the control circuit respectively detects the variations of the capacitance values ΔC1, ΔC2, ΔC3 and ΔC4 of the first direction control unit, the second direction control unit, the third direction control unit and the fourth direction control unit and calculates the coordinate of the center of gravity based on the aforementioned variations of the capacitance values, as follows:
XW1=(ΔC1×X1+ΔC2×X2×ΔC3×X3+ΔC4×X4)/(AC1×ΔC2+ΔC3+ΔC4)
YW1=(C1×Y1×ΔC2×Y2+ΔC3×Y3+ΔC4×Y4)/(AC1×ΔC2+ΔC3+ΔC4)
where (XW1,YW1) is the coordinate of the center of gravity on the first foot treadle;
wherein the control circuit respectively detects the variations of the capacitance values ΔC5, ΔC6, ΔC7 and ΔC8 of the fifth direction control unit, the sixth direction control unit, the seventh direction control unit and the eighth direction control unit and calculates the coordinate of the center of gravity based on the aforementioned variations of the capacitance values, as follows:
XW2=(ΔC5×X5+ΔC6×X6×ΔC7×X7×ΔC8×X8)/(C5+C6+C7+C8)
YW2=(ΔC5×Y5+ΔC6×Y6+ΔC7×Y7×ΔC8×Y8)/(ΔC5+ΔC6+ΔC7+ΔC8)
where (XW2,YW2) is the coordinate of the center of gravity on the second foot treadle.
